(19) United States
(12) Patent Application Publication
(10) Pub. No.: US 2007/0076976 A1
(43) Pub. Date: Apr. 5, 2007

(54) Methods for eliminating artifacts in two-dimensional optical metrology

(76) Inventors: Craig Uhrich, Redwood City, CA (US); Lanhua Wei, Fremont, CA (US); Jeffrey T. Fanton, Los Altos, CA (US); Ken Krieg, Fremont, CA (US)

Correspondence Address: STALLMAN & POLLOCK LLP, 353 SACRAMENTO STREET, SUITE 2200, SAN FRANCISCO, CA, 94111, US

(21) Appl. No.: 11/499,065

(22) Filed: Aug. 4, 2006

Related U.S. Application Data
(60) Provisional application No. 60/721,602, filed on Sep. 28, 2005.

(51) Int. Cl. G06K 9/40

(52) U.S. Cl. 382/275

(57) ABSTRACT

Methods for eliminating artifacts in two-dimensional optical metrology utilizing the interline CCD detectors are based on a dark-subtraction principle. The self-dark subtraction method takes advantage of strong correlation between the noise patterns in illuminated and dark regions within the same image. Image artifacts are removed and the S/N ratio is improved significantly by subtraction of selected dark region of the image from the illuminated one within the same frame. The dark-frame subtraction technique reduces a “smear” effect by applying a digital processing based on subtraction of the dark frame images from the normal light frame images. A combination of these methods significantly improves performance of two-dimensional optical metrology systems such as spectrometers, ellipsometers, beam profile reflectometers/ellipsometers, scatterometers and spectroscopic scatterometers.

### PRIORITY CLAIM

The present application claims priority to U.S. Provisional Patent Application Ser. No. 60/721,602, filed Sep. 27, 2005, the disclosure of which is incorporated herein by reference.

### TECHNICAL FIELD

The subject invention relates to optical metrology methods for inspecting and evaluating semiconductor wafers. The preferred embodiment is particularly suited for eliminating artifacts arising in the interline CCD in a two-dimensional (2D) optical metrology applications

### BACKGROUND OF THE INVENTION

There is considerable interest in monitoring the properties of semiconductors at various stages during the fabrication process. Monitoring the properties during fabrication allows the manufacturer to spot and correct process problems prior to the completion of the wafer.

The inspection of actual product wafers during or between process steps usually require non-contact techniques. Accordingly, a number of tools have been developed for optically inspecting semiconductor wafers. Such tools include reflectometers and ellipsometers. To increase the robustness of the measurements, these tools can often obtain measurements at multiple wavelengths and/or multiple angles of incidents using one-dimensional or two-dimensional CCD optical detectors.

Noise mitigation in multi-element optical detectors (1D line, and 2D array) has primarily focused on reducing the noise contribution due to “dark current”, which is due to electron accumulation at the optical sensor element, and “fixed pattern noise”, which is primarily due to variations in the detector element responsivity. “Fixed pattern noise” is, in fact not noise, since once measured, it is predictable.

Still other 2D detector “noise mitigation” or “noise reduction” techniques rely on non-linear processing of the pixels. Examples of these techniques are described in U.S. Pat. No. 6,731,806. However, these methods cannot be used in many optical metrology applications as they confound the later stages of processing needed to extract the surface metrology information.

However, scientific image detectors (such as would be used for precision metrology applications) have very little “fixed pattern noise” due to careful fabrication and device testing/selection. Therefore, noise mitigation for these detectors is primarily concerned with “dark noise”, 1/f noise, “burst noise”, and readout electronics thermal noise.

Most of the prior art “noise mitigation” techniques are designed for general application to arbitrary images and cannot take advantage of the substantial dark areas (portions of readout lines) within a frame that are present in two-dimensional optical metrology images.

Another example of prior art noise correction technique is described in U.S. Pat. No. 6,885,397. This patent discusses the use of embedded “correction” pixels, where the “corrector” pixels are used to correct the values of the “light-sensitive” pixels. However, the “dark” or “reference pixels” discussed in this patent are specially configured to avoid illumination and the “image correction” employed uses a circuit for correction.

Yet another example of noise reduction method is described in the publication “A Temporal Noise Reduction Filter Based on Image Sensor Full-Frame Data” by A. Bosco, K. Findlater, S. Battiato, A. Castorina published in Proceedings of IEEE ICCE 03—International Conference on Consumer Electronics, June 2003, pp. 402-403. This paper describes the use of embedded “dark lines” in an image, but instead of subtracting the “local dark reference” pixels directly from neighboring pixels (pixels within the same line), it teaches the use of a much more complicated non-linear filter whose operation depends on multi-frame “dark line” statistics. Such a filter and method would be inappropriate for optical metrology applications, as it can produce erroneous outputs from the subsequent estimation algorithms.

Yet another example of noise reduction techniques is described in U.S. Pat. No. 4,032,975. This is one is directed to methods for “pattern noise” reduction. However, this method applies mainly to noise that is “fixed” across the field of the 2D detector (often referred to as “fixed pattern noise”). Therefore, this method cannot reduce low-frequency (1/f) noise that is found in the detector elements and in the “readout” electronics.

Another example of “dark noise” reduction, correction and mitigation techniques is described in U.S. Pat. No. 5,355,164. This patent discusses the use of “blind” pixels (light-shielded pixels on a 2D imaging array) to estimate the dark-current. This method relies on pixels that are at the outer edges of the 2D imaging detector and so, are not near to the image of interest. Because, upon readout, the “blind” pixels discussed in this patent are not temporally close to the imaging pixels, low-frequency noise is not reduced.

Yet another example of dark signal compensation in 2D arrays is disclosed in U.S. Pat. No. 4,933,543. This patent is typical of many of the prior art techniques used to reduce dark-noise, that is the use of “shielded” or “masked” pixels (the “dark” pixels) to obtain values for correction of the image pixels. As a result, the technique of this patent cannot compensate for “noise” introduced by stray reflected light, whose value may change with the illuminated image.

For at least the reasons discussed above, all prior art image improvement and artifacts eliminating techniques are not suitable for their application to image processing in two-dimensional semiconductor optical metrology. A need exists for a simple and reliable method for eliminating image artifacts and improving signal-to-noise (S/N) ratio suitable for commercial optical metrology applications.

### SUMMARY OF THE INVENTION

The subject invention describes two methods for eliminating artifacts in two-dimensional optical metrology utilizing the interline CCD detectors. These methods are based on a dark-subtraction principle. Self-dark subtraction method takes advantage of strong correlation between the noise patterns in illuminated and dark regions within the same image. Image artifacts are removed and the S/N ratio is improved significantly by subtraction of selected dark region of the image from the illuminated one within the same frame. Dark-frame subtraction technique reduces a “smear” effect by applying a digital processing based on subtraction of the dark frame images from the normal light frame images. Both methods are suitable for application to images obtained using two-dimensional optical metrology systems such as spectrometers, ellipsometers, beam profile reflectometers/ellipsometers, scatterometers and spectroscopic scatterometers.

### BRIEF DESCRIPTION OF THE DRAWINGS

FIG. 1 shows a two-dimensional image with illuminated and dark regions

FIG. 2 shows a two-dimensional image with several illuminated and dark areas selected for image processing.

FIG. 3 shows noise patterns for selected illuminated areas of the image

FIG. 4 shows noise patterns for selected dark areas of the image

FIG. 5 shows a noise floor caused by coherent fluctuations in CCD background

FIG. 6 shows a reduced noise pattern for processed image area

FIG. 7 shows noise floors for the original and processed areas of the image

FIG. 8 illustrates an algorithm for self-dark region subtraction

FIG. 9A shows a two-dimensional image of the light frame

FIG. 9B shows a two-dimensional image of a dark frame

FIG. 9C shows the result of the dark-frame subtraction method

FIG. 10 shows an improved noise floor for the self-dark and dark-frame subtraction techniques

### DETAILED DESCRIPTION OF THE PREFERRED EMBODIMENTS

Self-Dark Subtraction Method.

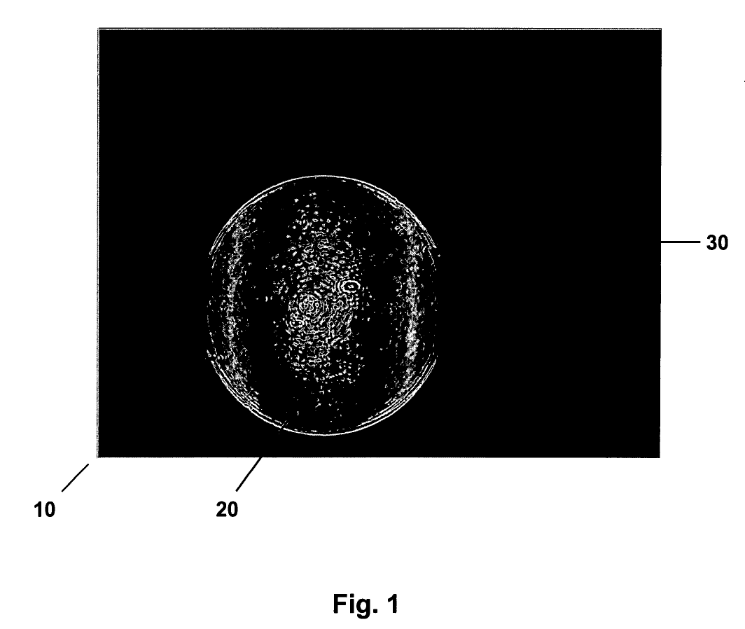

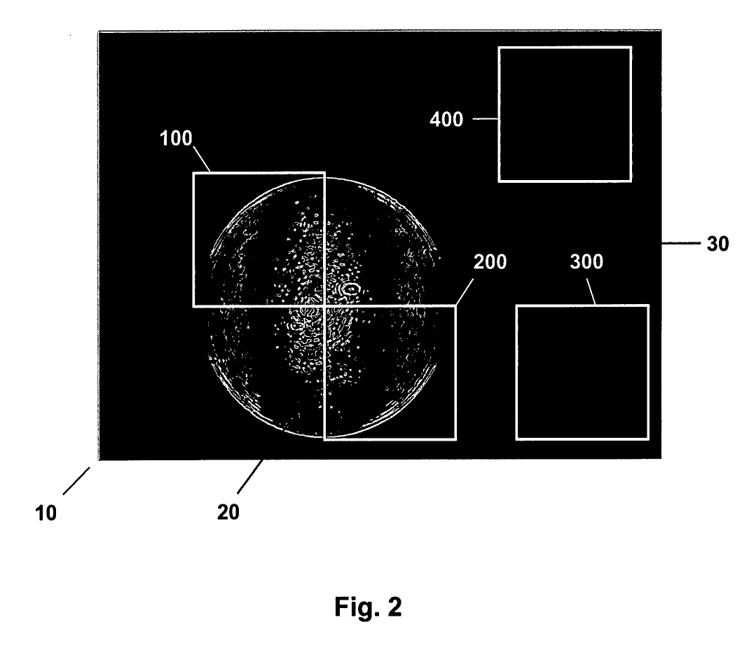

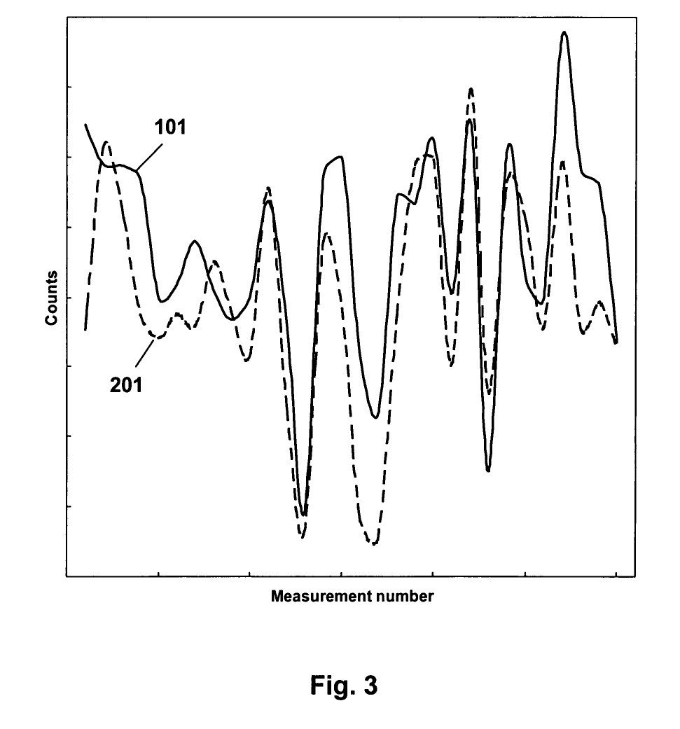

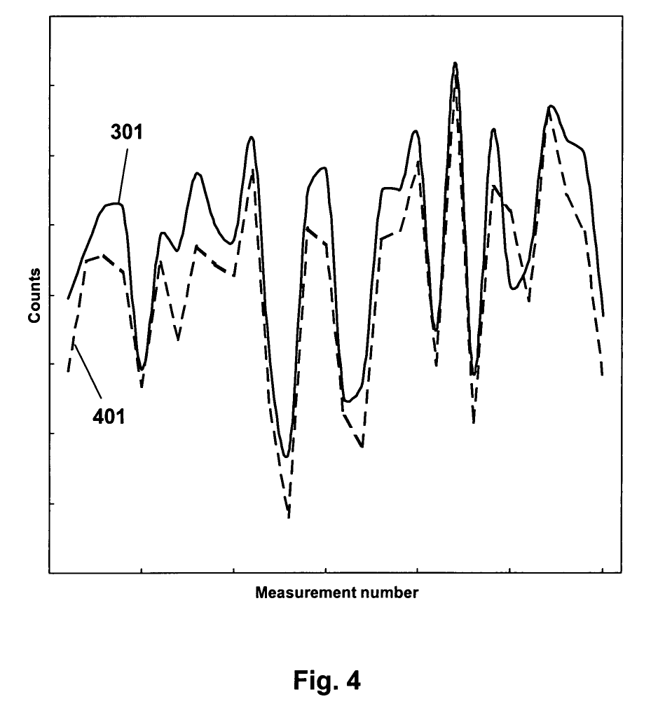

In two-dimensional optical metrology, CCD detectors are used to capture images of the sample. These detectors are known to suffer from electronic fluctuations in the dark signal. FIG. 1 shows an example of image 10 captured using an optical metrology system. This image consists from the illuminated region 20 and the dark region 30. Electronic fluctuations (or noise) in different parts of the same image are often of coherent nature, e.g. the light intensities captured by CCD detector in these areas change in a correlated manner. To illustrate this correlated noise behavior, two illuminated regions 100 and 200 of image 10 are selected along with two dark regions 300 and 400, as shown in FIG. 2. A series of images is obtained using two-dimensional optical metrology system and the resulting intensities for regions 100-400 are recorded and plotted on the same graphs. FIG. 3 shows highly correlated intensity patterns 101 and 201 corresponding to illuminated regions 100 and 200 of FIG. 2. FIG. 4 illustrates the same high degree of correlation observed for ntensity patterns 301 and 401 from dark regions 300 and 400 of FIG. 2.

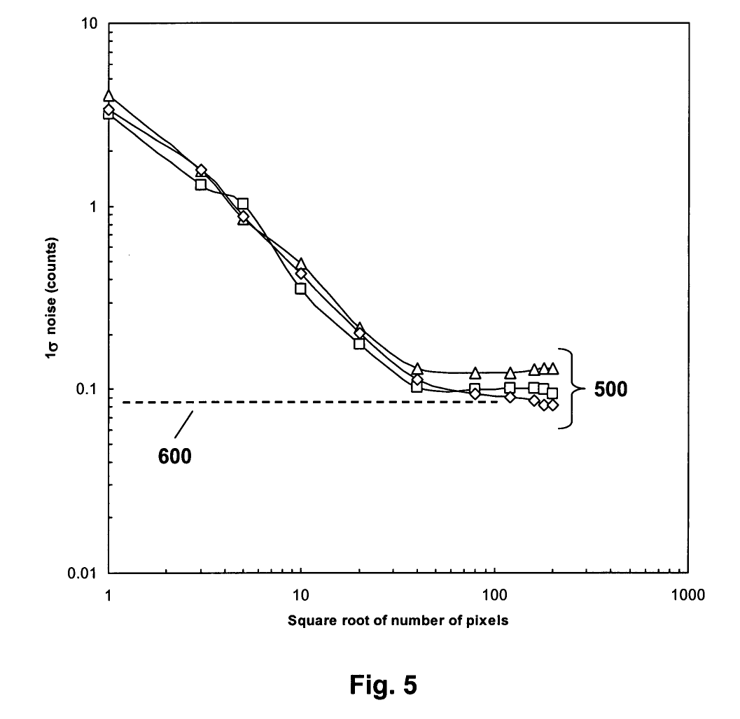

These coherent fluctuations set a noise floor and, therefore, limit the S/N ratio that can be achieved for an optical metrology system in this application. FIG. 5 illustrates this effect by showing non-monotonic dependencies 500 of noise in the illuminated region of image 10 on the number of pixels that saturate at a certain (floor) level 600. The performance of an optical metrology system depends on the position of noise floor 600. The lower is the noise floor, the better is the S/N ratio of an optical metrology system. It was found that this noise floor effect can degrade the S/N ratio of the optical instrument by a factor of 3 to 10 depending on certain experimental conditions.

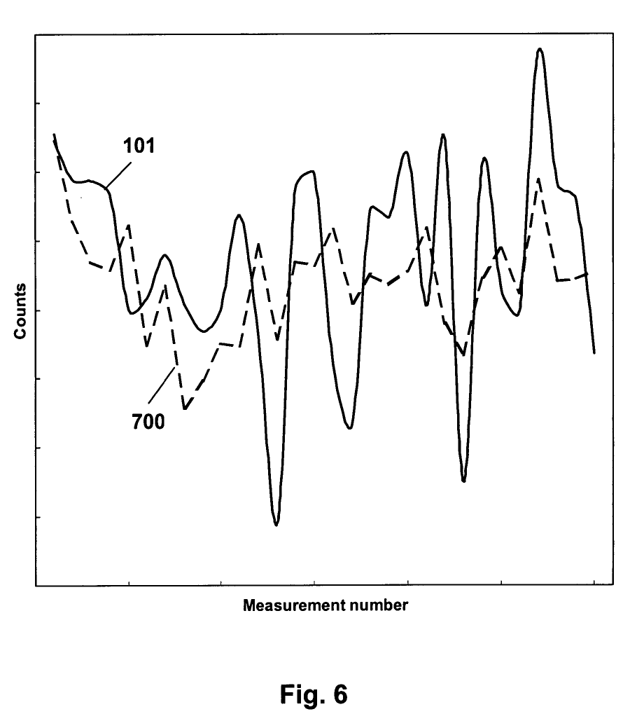

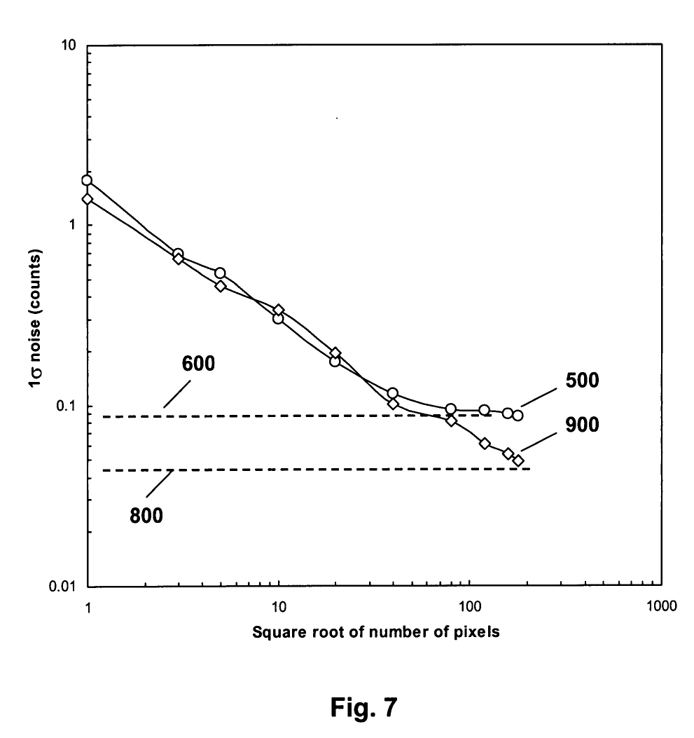

However, since these coherent fluctuations have similar patterns and comparable intensities in both illuminated regions and dark regions within the same frame (FIG. 2 and FIG. 3), image artifacts can be removed and the S/N increased by subtracting the dark regions intensities from the illuminated regions intensities of the same image. FIG. 6 shows significantly reduced intensities pattern 700 obtained as a result of such subtraction compared to the intensities pattern of the illuminated region 101 before subtraction. For the subtracted image, the noise pattern 900 exhibits a monotonic decrease and the noise level 800 is improved significantly compared to the original noise floor 600 as shown in FIG. 7.

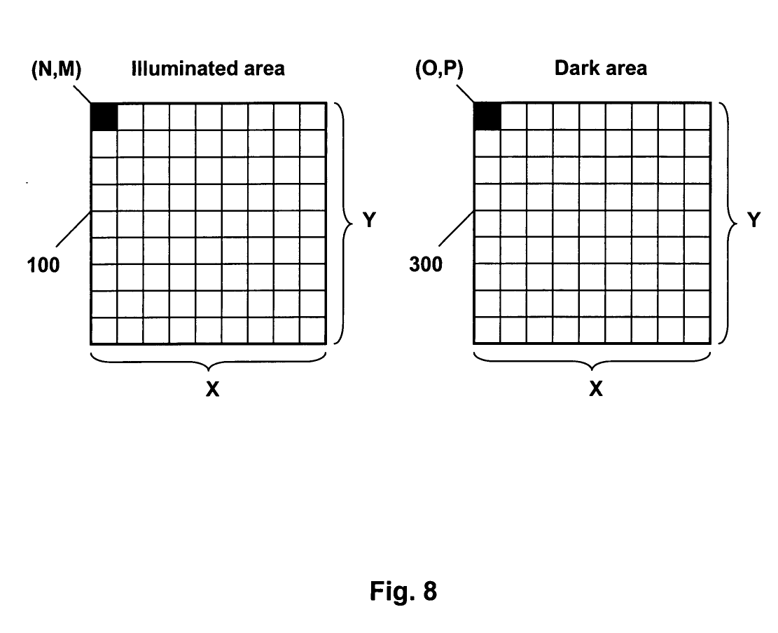

The self-dark subtraction algorithm can have a number of variants, depending on the degree and type of correlation within the frame and between the frames. In the preferred embodiment, the self-dark subtraction method subtracts the dark-region of the image (area 300 or 400 in FIG. 2) pixel-by-pixel from a corresponding region in the illuminated portion of the frame (areas 100 or 200 in FIG. 2). For example, if the illuminated area 100 region has a pixel (N, M) as its upper left pixel and is X pixels in width and Y pixels in height and the area 300 dark region has (O, P) as its upper left pixel, then one form of the self-dark subtraction algorithm is:
new_pixel(N+i,M+j)=pixel(N+i,M+j)−pixel(O+i,P+j), for i=0 to X−1,j=0 to Y−1 (1)
as shown schematically in FIG. 8. Other embodiments can use the average or median value of the self-dark regions, instead of the individual pixels, or require the M and P starting pixels to be equal (self-dark subtraction of a horizontally adjacent dark region of the frame). The common important feature of any of these embodiments is that the dark region to be subtracted from the illuminated region is present in the same frame.
Dark-Frame Subtraction Method.

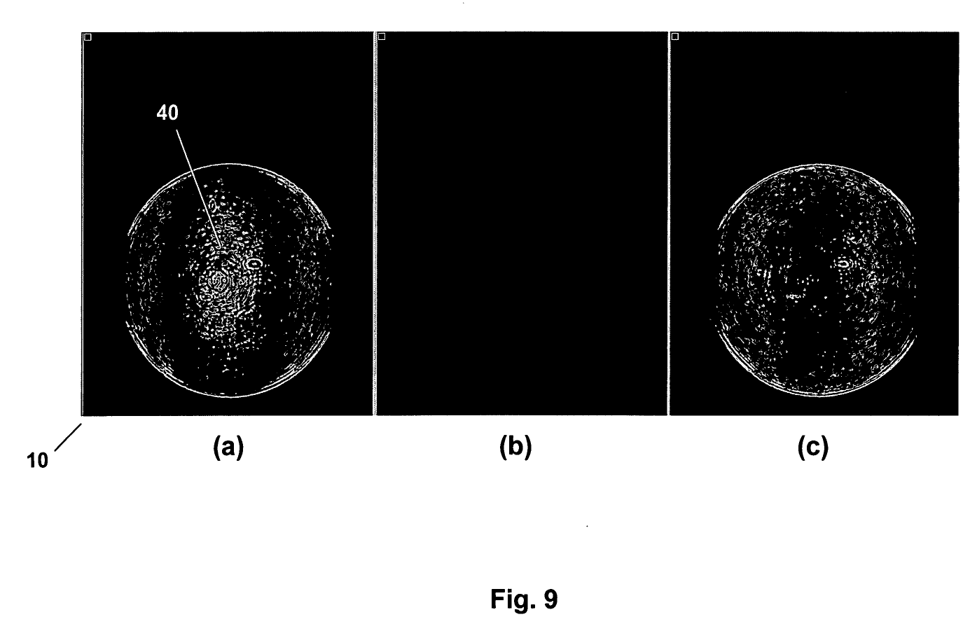

Interline CCD cameras can suffer from a smear effect due to light leakage into the nominally covered readout pixels. This spurious smear signal adds to the intended image captured by the camera. It has been found that, the “dark frame”, e.g. the frame taken when the electronic shutter is closed (active pixels being reset), carries the same smear information as the normal light frame image taken during a normal capture. Therefore, the dark frames can be used to remove the artifacts caused by the smear effect from the images, as illustrated in FIG. 9. In this figure, a smear 40 in the image 10 is effectively removed (FIG. 9C) by subtracting the dark frame (FIG. 9B) from the light (or sample) frame shown in FIG. 9A.

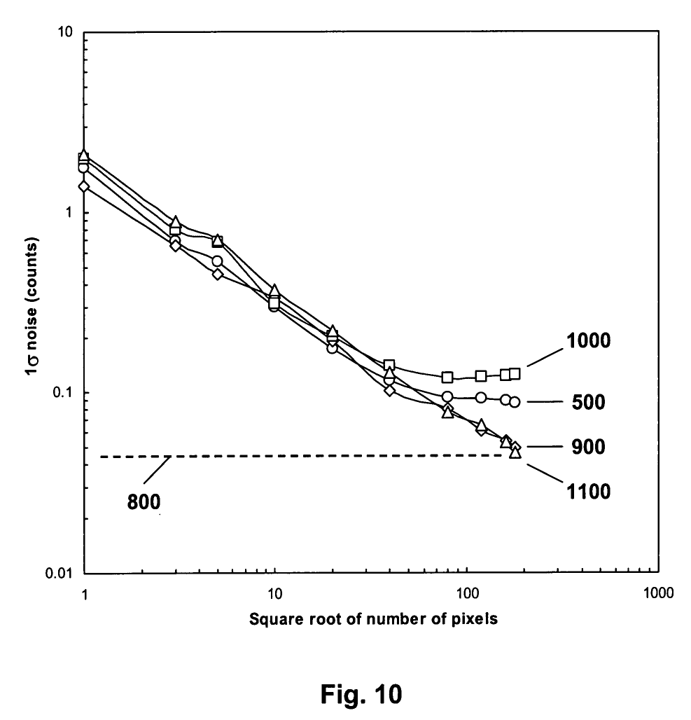

It has been found that the dark-frame subtraction without the self-dark subtraction adds extra noise to the original signal. In FIG. 10, the noise pattern 1000 corresponding to the dark-frame subtraction only has a much higher noise floor than the combined self-dark and dark-frame subtraction (1100). Therefore, the combination of the two dark-subtraction methods is more beneficial as it significantly improves precision of an optical metrology system while removing the smear artifacts. In the event both the dark-subtraction methods are used, it is preferable to perform the dark-frame subtraction method before the self-dark subtraction method.

We claim:

1. A method of reducing artifacts in an image obtained in an optical metrology device, said device including detector defined by a two dimensional array of photodetecting elements for measuring the intensity of a probe beam spot imaged onto the detector, said method comprising the steps of:
sampling the output of the photodetecting elements lying outside the imaged beam spot; and
correcting the intensity measurements of the photodetecting elements from within the imaged beam spot based on the sampled output from outside the beam spot.

2. A method as recited in claim 1, wherein said correcting step is performed by subtracting the average output of the sampled photodetecting elements lying outside the beam spot from the intensity measurements within the beam spot.

3. A method as recited in claim 1, wherein said sampling step includes selecting a first region of photodetecting elements lying outside the beam spot and said correcting step is performed on a second region within the beam spot, with said first and second regions having a similar shape and size.

4. A method as recited in claim 3, wherein said correcting step is performed on an element by element basis, wherein the output of one element lying in the first region is used to correct the intensity measurement of one element in the second region.

5. A method as recited in claim 4, wherein the correcting step is performed by subtracting the output of the element lying in the first region with the intensity measurement in the second region.

6. A method as recited in claim 4, wherein the elements in the first region used to correct the measurement of the elements in the second region occupy correspondingly similar locations in the first region and second regions.

7. A method as recited claim 3, wherein said correcting step is performed using a median value of the output of the elements in the first region.

8. A method as recited in claim 7, wherein the correcting step includes subtracting the median valued of the output of the elements in the first region from the intensity measurements of the second region.

9. A method as recited in claim 1, further including the step of determining the output of the photodetecting elements when the probe beam is not illuminating the detector and correcting the intensity measurements of the photodetecting element taken when the probe beam is illuminating the detector with the output determined when the probe beam is not illuminating the array.

10. A method as recited in claim 9, wherein the determining and correcting steps of claim 9 are performed before the correcting step of claim 1.

11. A method as recited in claim 1, wherein the optical metrology device includes at least one or more of the type selected from the group consisting of a spectrometer, an ellipsometer, a beam profile reflectometer, a beam profile ellipsometer, a scatterometer and a spectroscopic scatterometer.
